(19) United States
(12) Patent Application Publication
(10) Pub. No.: US 2026/0235153 A1
(43) Pub. Date: Aug. 13, 2026

(54) ANTI-ROTATION MOUNTING ASSEMBLY FOR AN AIRCRAFT STRUCTURE

(71) Applicant: Rohr, Inc., Chula Vista, CA (US)

(72) Inventors: Preston G. McCartney, San Diego, CA (US); Jihad I. Ramlaoui, Chula Vista, CA (US)

(21) Appl. No.: 19/540,234

(22) Filed: Feb. 13, 2026

Related U.S. Application Data
(60) Provisional application No. 63/758,164, filed on Feb. 13, 2025.

(51) Int. Cl. F16B 33/00; F16B 21/02; H02G 3/32

(52) U.S. Cl. CPC F16B 33/002; F16B 21/02; H02G 3/32

(57) ABSTRACT

An anti-rotation mounting assembly includes a base member, a component, a bracket, and a cable. The base member includes a threaded aperture and a dowel aperture. The threaded aperture extends along a mating axis. The dowel aperture is disposed radially outward of the threaded aperture. The component includes a threaded element at the threaded aperture. The bracket includes a first portion, a second portion, and a third portion. The first portion includes a ring and a dowel. The ring is disposed between and contacts the base member and the component. The ring circumscribes the threaded element. The dowel is disposed within the dowel aperture. The second portion extends between the first portion and the third portion. The third portion is disposed radially outward of the component. The cable extends between a first cable end and a second cable end. The cable is engaged with the component and the third portion.

This application claims priority to U.S. Patent Appln. No. 63/758,164 filed February 13, 2025, which is hereby incorporated herein by reference in its entirety.

### BACKGROUND

### 1. Technical Field

The present disclosure relates generally to mounting assemblies and, more particularly, to anti-rotation mounting assemblies for securing components to structures, including aircraft structures.

### 2. Background Information

Components may be mounted to aircraft structures using a variety of known mounting arrangements. While these known mounting arrangements may be suitable for their intended purposes, there is always room in the art for improvement.

### SUMMARY

According to an aspect of the present disclosure, an anti-rotation mounting assembly for an aircraft structure includes a base structural member, a component, an anti-rotation bracket, and a safety cable. The base structural member includes a threaded aperture and a dowel aperture. The threaded aperture extends along a mating axis. The dowel aperture is disposed radially outward of the threaded aperture. The component includes a threaded element. The threaded element is engaged with the base structural member at the threaded aperture. The anti-rotation bracket includes a first body portion, a second body portion, and a third body portion. The first body portion includes a ring and a dowel. The ring is disposed axially between and contacts the base structural member and the component. The ring circumscribes the threaded element. The dowel is disposed within the dowel aperture. The second body portion extends between and to the first body portion and the third body portion. The third body portion is disposed radially outward of the component. The safety cable extends between and to a first cable end and a second cable end. The safety cable is engaged with the component at the first cable end. The safety cable is engaged with the third body portion at the second cable end.

In any of the aspects or embodiments described above or herein, the threaded aperture may extend through the base structural member from a second base end toward a first base end along the mating axis.

In any of the aspects or embodiments described above or herein, the dowel aperture may be formed in the base structural member at a circumferential position radially outward of the threaded aperture.

In any of the aspects or embodiments described above or herein, the base structural member may form a mating surface extending radially outward from the threaded aperture, and the ring may be disposed in contact with the mating surface.

In any of the aspects or embodiments described above or herein, the ring may be disposed axially between the mating surface of the base structural member and a mating surface of the component.

In any of the aspects or embodiments described above or herein, the dowel may be disposed on the ring and may project axially outward from the ring toward the base structural member.

In any of the aspects or embodiments described above or herein, the dowel may extend parallel to the mating axis.

In any of the aspects or embodiments described above or herein, the second body portion may include an axial segment extending from the ring and a radial segment extending from the axial segment.

In any of the aspects or embodiments described above or herein, the third body portion may extend axially from the radial segment and may be oriented substantially orthogonal to the ring.

In any of the aspects or embodiments described above or herein, the component may forma cable groove recessed into an outer radial side of the component.

In any of the aspects or embodiments described above or herein, the cable groove may extend circumferentially about the mating axis.

In any of the aspects or embodiments described above or herein, the component may form a first cable aperture extending through the component body, and the safety cable may extend through the first cable aperture from the cable groove to an exterior of the component body.

In any of the aspects or embodiments described above or herein, the safety cable may extend through the first cable aperture in a direction transverse to a radial orientation of the cable groove.

In any of the aspects or embodiments described above or herein, the third body portion may form a second cable aperture disposed at an axial position of the cable groove.

In any of the aspects or embodiments described above or herein, the ring may form a center aperture extending along the mating axis, the threaded element may extend through the center aperture with radial clearance, and the ring may be disposed axially between the base structural member and the component.

According to another aspect of the present disclosure, a method includes mounting a base structural member to a structure. The base structural member includes a threaded aperture extending along a mating axis and a dowel aperture disposed radially outward of the threaded aperture. The method further includes positioning an anti-rotation bracket relative to the base structural member such that a dowel of the anti-rotation bracket is received within the dowel aperture. The anti-rotation bracket includes a ring and a third body portion disposed radially outward of the component. The method further includes threading a threaded element of the component into the threaded aperture such that the ring is disposed axially between and contacts the base structural member and the component and routing a safety cable between the component and the third body portion of the anti-rotation bracket, including extending the safety cable through a first cable aperture formed in the component, through a cable groove formed in the component, and through a second cable aperture formed in the third body portion.

In any of the aspects or embodiments described above or herein, the method may further include routing the safety cable circumferentially about the mating axis in a direction opposing an unthreading rotational direction of the component.

In any of the aspects or embodiments described above or herein, the method may further include positioning the ring between the base structural member and the component during threading of the threaded element such that the ring contacts both the base structural member and the component.

In any of the aspects or embodiments described above or herein, the method may further include engaging the dowel of the anti-rotation bracket within the dowel aperture prior to threading the threaded element into the threaded aperture.

In any of the aspects or embodiments described above or herein, the method may further include fixing a first retention member on the safety cable adjacent the first cable end and fixing a second retention member on the safety cable adjacent the second cable end after routing the safety cable through the first cable aperture, the cable groove, and the second cable aperture.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 illustrates a perspective view of an aircraft, in accordance with one or more embodiments of the present disclosure.

FIG. 2 illustrates a perspective view of an aircraft structure and an anti-rotation mounting assembly installed on the aircraft structure, in accordance with one or more embodiments of the present disclosure.

FIG. 3 illustrates a cutaway, side view of the aircraft structure and the anti-rotation mounting assembly taken along Line A-A of FIG. 2, in accordance with one or more embodiments of the present disclosure.

FIG. 4 illustrates a cross-sectional view of the aircraft structure and the anti-rotation mounting assembly taken along Line B-B of FIG. 2, in accordance with one or more embodiments of the present disclosure.

FIG. 5 illustrates a more detailed view of the anti-rotation mounting assembly in the Area Y of FIG. 4, front view of the thrust reverser, in accordance with one or more embodiments of the present disclosure.

### DETAILED DESCRIPTION

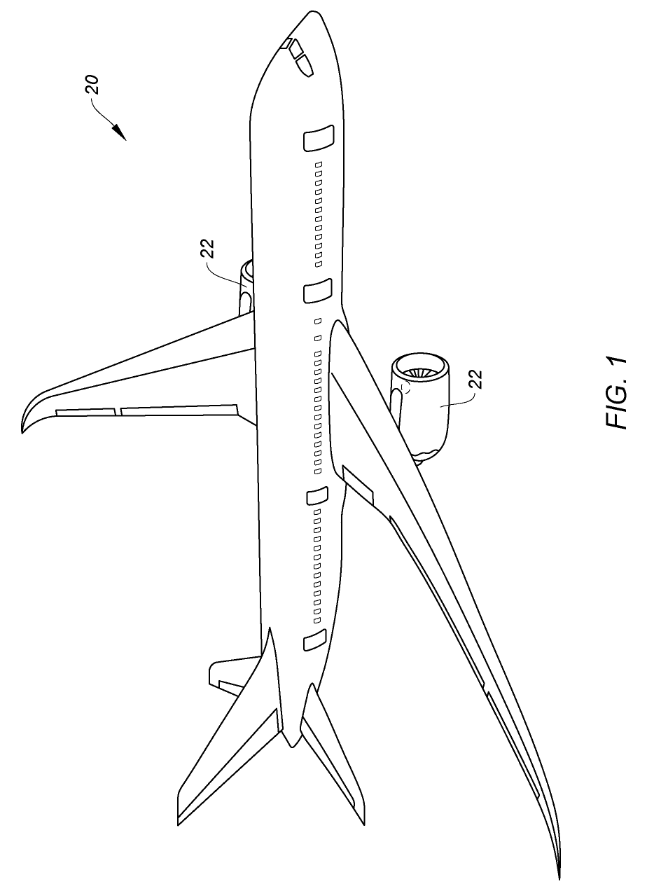

FIG. 1 illustrates a perspective view of an aircraft 20 including at least one propulsion system 22. Briefly, the aircraft 20 may be a fixed-wing aircraft (e.g., an airplane) as shown, for example, in FIG. 1. However, the aircraft 20 may alternatively be a rotary-wing aircraft (e.g., a helicopter or other rotorcraft), a tilt-rotor aircraft, a tilt-wing aircraft, or another aerial vehicle. Moreover, the aircraft may be a manned aerial vehicle or an unmanned aerial vehicle (UAV, e.g., a drone).

In certain operating environments, threaded components mounted to aircraft structures may be subjected to sustained vibration, thermal cycling, or other dynamic loads that can result in a reduction of prevailing torque in a threaded joint. Such reduction in prevailing torque may permit relative rotation between mating threaded elements, potentially leading to loosening, loss of preload, and unintended separation or departure of the mounted component from its designed position. Traditional anti-loosening approaches, such as safety wiring routed between multiple adjacent fastener heads or tabs, may be impractical in compact installations or where only a single mounting location is available.

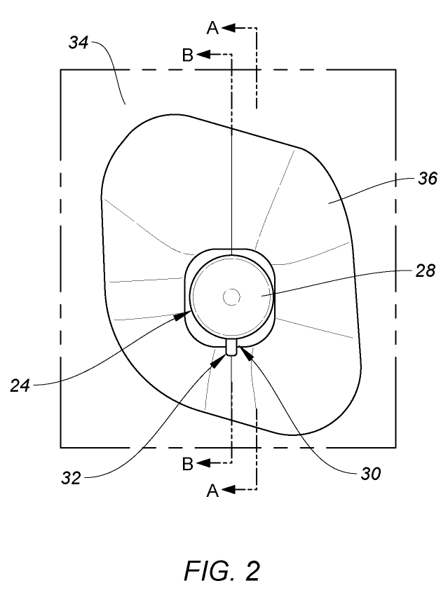

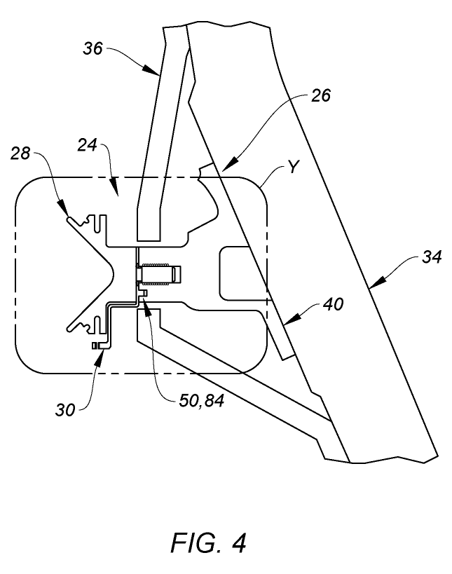

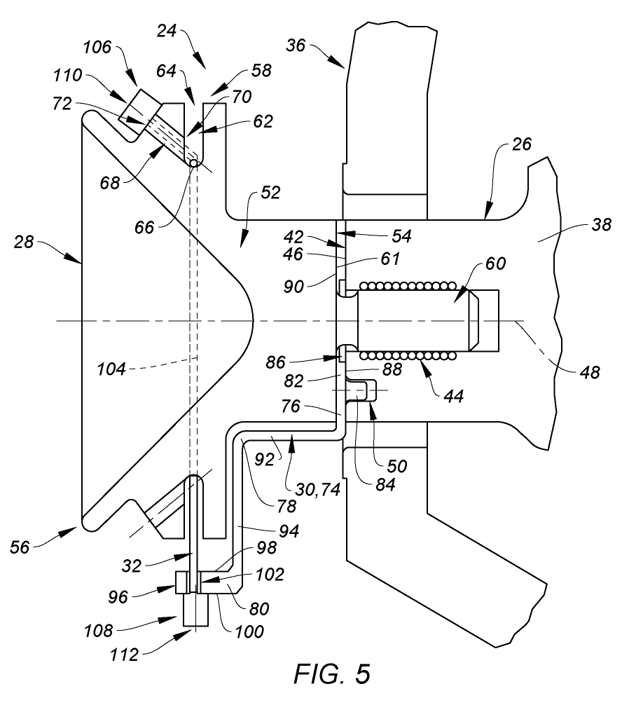

FIGS. 2-5 illustrate an anti-rotation mounting assembly 24 which may be used for an aircraft such as the aircraft 20 or its propulsion system 22. For example, the anti-rotation mounting assembly may facilitate mounting a component to a structure of the aircraft 20 (e.g., a fuselage, a nacelle, a wing, or another aerostructure). The anti-rotation mounting assembly 24 of the present disclosure, however, is not limited to aircraft applications.

The anti-rotation mounting assembly 24 includes a base structural member 26, a component 28, an anti-rotation bracket 30, and a safety cable 32. The base structural member 26 is mounted (e.g., fixedly mounted) to a structure 34 (e.g., an aerostructure component) of the aircraft 20. As shown in the figures, the base structural member 26 may extend through an adjacent structure 36 of the aircraft 20. In other embodiments, the base structural member 26 may be mounted to the structure 34 without extending through an adjacent structure. The adjacent structure 36 may be mounted to or otherwise disposed at (e.g., on, adjacent, or proximate) the structure 34. The adjacent structure 36 may be positioned such that at least a portion of the base structural member 26 is disposed between the structure 34 and the adjacent structure 36. A portion of the base structural member 26 may extend through the adjacent structure 36 (e.g., an aperture of the adjacent structure 36).

The base structural member 26 includes a base body 38. The base body 38 extends between and to a first base end 40 of the base body 38 and a second base end 42 of the base body 38. The first base end 40 is disposed on (e.g., mounted to) the structure 34. The base body 38 forms a threaded aperture 44 and a mating surface 46 of the base structural member 26 on the second base end 42. The threaded aperture 44 extends on and along a mating axis 48, which mating axis 48 forms a centerline of the threaded aperture 44. In particular, the threaded aperture 44 extends through the base body 38 along the mating axis 48 from the second base end 42 toward the first base end 40. The mating surface 46 extends along the second base end 42 radially outward from the threaded aperture 44. For example, the mating surface 46 may be a flat surface extending orthogonal to substantially orthogonal relative to the mating axis 48. The mating surface 46 extends circumferentially about (e.g., completely around) the threaded aperture 44 and the mating axis 48 on the second base end 42. The base body 38 forms a dowel aperture 50 on the second base end 42. The dowel aperture 50 is disposed radially outward of the threaded aperture 44 at a circumferential portion of the second base end 42. The dowel aperture 50 extends through the base body 38 (and the mating surface 46) from the second base end 42 toward the first base end 40. The dowel aperture 50 may extend parallel to or substantially parallel to the mating axis 48 from the second base end 42 toward the first base end 40.

The component 28 includes a component body 52. The component body 52 extends along the mating axis 48 between and to a first component end 54 (e.g., a first axial end) of the component body 52 and a second component end 56 (e.g., a second axial end) of the component body 52. The component body 52 forms an outer radial side 58 extending circumferentially about (e.g., completely around) the mating axis 48. The component body 52 forms a threaded element 60 and a mating surface 61. The threaded element 60 (e.g., a threaded male fitting) is disposed at the first component end 54. The threaded element 60 extends on and along the mating axis 48. The threaded element 60 is mounted in threaded engagement with the base body 38 within the threaded aperture 44 such that the threaded element 60 may be threaded into or threaded out of the base body 38 by rotation of the component 28 about the mating axis 48. The mating surface 61 extends radially outward from the threaded element 60. For example, the mating surface 61 may extend radially outward from the threaded element 60 at (e.g., on, adjacent, or proximate) an axial end of the threaded element 60 opposite the first component end 54. The mating surface 61 may be a flat surface extending orthogonal or substantially orthogonal relative to the mating axis 48. The component body 52 forms a cable groove 62 on the outer radial side 58. The cable groove 62 may be disposed at an intermediate axial position of the component body 52 between the first component end 54 and the second component end 56. The cable groove 62 may extend circumferentially about (e.g., completely around) the mating axis 48 on the outer radial side 58. The cable groove 62 extends radially through the component body 52 from an outer radial end 64 of the cable groove 62 to an inner radial end 66 of the cable groove 62. The outer radial end 64 is disposed at (e.g., on, adjacent, or proximate) the outer radial side 58. The component body 52 further forms a first cable aperture 68. The first cable aperture 68 extends through the component body 52 from a first aperture end 70 of the first cable aperture 68 to a second aperture end 72 of the first cable aperture 68. The first cable aperture 68 may extend from the first aperture end 70 to the second aperture end 72 in a direction transverse to the radial orientation of the cable groove 62. For example, this transverse direction may include both of an axial component and a radial component. The first aperture end 70 is disposed on the cable groove 62, for example, at (e.g., on, adjacent, or proximate) the inner radial end 66. The second aperture end 72 is disposed on an exterior of the component body 52, for example, at (e.g., on, adjacent, or proximate) the outer radial side 58.

The component 28 may include any of a variety of functional elements requiring secure threaded mounting, including but not limited to sensors, actuators, fittings, studs, brackets, or other hardware mounted to an aircraft structure or to a non-aircraft structure. The anti-rotation mounting assembly 24 is not limited to a particular type or function of the component 28, provided that the component includes a threaded element configured for engagement with the base structural member 26.

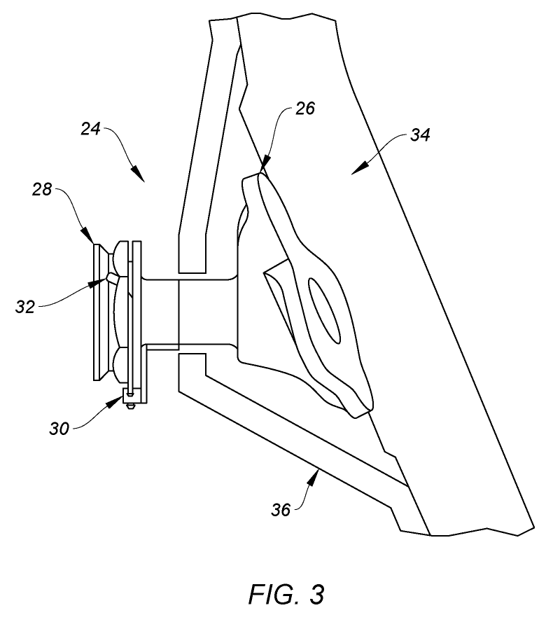

The anti-rotation bracket 30 includes a bracket body 74. The bracket body 74 includes a first body portion 76, a second body portion 78, and a third body portion 80. The first body portion 76 forms a ring 82 and a dowel 84. This ring 82 may be understood as a generally flat, circular body portion forming a center aperture 86. The ring 82 extends between and to a first side surface 88 of the ring 82 and a second side surface 90 of the ring 82. The center aperture 86 extends on and along the mating axis 48 from the first side surface 88 to the second side surface 90. The threaded element 60 extends through the center aperture 86 to the threaded aperture 44 such that the ring 82 circumscribes the threaded element 60 (e.g., with a radial clearance). The first side surface 88 contacts the base body 38 (e.g., the mating surface 46). The second side surface 90 contacts the component body 52 (e.g., the mating surface 61). The ring 82 bears the axial pre-load of the component 28 mounted to the base structural member 26. The dowel 84 is disposed on the first side surface 88 and projects axially outward from the first side surface 88. The dowel 84 is disposed within the dowel aperture 50 to prevent rotation (e.g., about the mating axis 48) of the anti-rotation bracket 30 relative to the base structural member 26. The second body portion 78 extends between and interconnects the first body portion 76 and the third body portion 80. The second body portion 78 of FIGS. 3-5, for example, includes an axial segment 92 and a radial segment 94. The present disclosure, however, is not limited to this foregoing exemplary configuration of the second body portion 78. The third body portion 80 extends between and to the second body portion 78 and a distal axial end 96 of the bracket body 74. The third body portion 80 extends axially or substantially axially from the second body portion 78 (e.g., the radial segment 94) to the distal axial end 96. For example, the third body portion 80 may be oriented orthogonal or substantially orthogonal to the first body portion 76 (e.g., the ring 82). The third body portion 80 is disposed radially outward of (e.g., and spaced from) the outer radial side 58. The third body portion 80 extends (e.g., radially extends) between and to an inner radial surface 98 of the third body portion 80 and an outer radial surface 100 of the third body portion 80. The inner radial surface 98 faces the component 28 and the outer radial surface 100 faces away from the component 28. The third body portion 80 forms a second cable aperture 102. The second cable aperture 102 extends through the third body portion 80 from the inner radial surface 98 to the outer radial surface 100. The second cable aperture 102 is disposed at (e.g., on, adjacent, or proximate) an axial position of the cable groove 62.

The safety cable 32 includes a cable body 104 (e.g., a braided-wire cable body). The cable body 104 extends between and to a first cable end 106 of the cable body 104 and a second cable end 108 of the cable body 104. The safety cable 32 further includes a first retention member 110 and a second retention member 112. Each of the first retention member 110 and the second retention member 112 forms an enlarged body (e.g., relative to the cable body 104 diameter and the cable aperture 68, 102 diameters) which is configured to be positionally fixed on the cable body 104. For example, the first retention member 110 and the second retention member 112 may be configured as ferrules crimped onto the cable body 104. The first retention member 110 is fixed on the cable body 104 and disposed at (e.g., on, adjacent, or proximate) the first cable end 106. The second retention member 112 is fixed on the cable body 104 and disposed at (e.g., on, adjacent, or proximate) the second cable end 108. The safety cable 32 is engaged with and between the component body 52 and the bracket body 74 (e.g., the third body portion 80). The cable body 104 extends through the first cable aperture 68, the cable groove 62, and the second cable aperture 102 along a length of the cable body 104 from the first cable end 106 to the second cable end 108. The first cable end 106 and the first retention member 110 are disposed at (e.g., on, adjacent, or proximate) the component body 52 at (e.g., on, adjacent, or proximate) the first cable aperture 68 (e.g., the second aperture end 72). The second cable end 108 and the second retention member 112 are disposed at (e.g., on, adjacent, or proximate) the outer radial surface 100 at (e.g., on, adjacent, or proximate) the second cable aperture 102. The cable body 104 is routed through the cable groove 62, from the first cable aperture 68 to the second cable aperture 102 in a circumferential direction opposing an unthreading rotational direction of the component 28. In other words, the safety cable 32 engaged with the component 28 and the anti-rotation bracket 30 prevents unthreading of the component 28 from the base structural member 26 (e.g., the safety cable 32 rotationally fixes the component 28 relative to the base structural member 26 and the anti-rotation bracket 30).

In some embodiments, the cable groove 62 and the first and second cable apertures 68, 102 may be positioned such that the safety cable 32 is routed circumferentially about the mating axis 48 in a direction selected to oppose an unthreading rotational direction of the component 28. In this configuration, attempted loosening rotation of the component 28 places the safety cable 32 in tension, thereby resisting further rotation and maintaining the threaded engagement between the threaded element 60 and the threaded aperture 44.

In operation, the anti-rotation bracket 30 cooperates structurally with the base structural member 26, the component 28, and the safety cable 32 to maintain both axial preload and rotational fixation of the component 28. The ring 82 of the first body portion 76 is disposed axially between the base structural member 26 and the component 28 such that axial preload generated by threaded engagement of the threaded element 60 within the threaded aperture 44 is reacted through the ring 82, rather than through the dowel 84 or the safety cable 32. The dowel 84, received within the dowel aperture 50, inhibits relative rotation of the anti-rotation bracket 30 with respect to the base structural member 26, thereby establishing a fixed angular reference. The safety cable 32 then mechanically couples the component 28 to the third body portion 80 of the anti-rotation bracket 30, such that rotational movement of the component 28 relative to the base structural member 26 is resisted without relying on deformation of the threaded element 60 or the use of adjacent fasteners. The present disclosure anti-rotation mounting assembly 24 facilitates compact, self-contained anti-rotation at a single mounting site, for example, while maintaining controlled axial preload and permitting repeatable installation and inspection.

In an exemplary installation, the base structural member 26 may be mounted to the structure 34, after which the anti-rotation bracket 30 may be positioned such that the dowel 84 is received within the dowel aperture 50. The component 28 is then threaded into the threaded aperture 44 to a desired preload, with the ring 82 bearing axially between the base structural member 26 and the component 28. The safety cable 32 is routed through the first cable aperture 68, the cable groove 62, and the second cable aperture 102, and the first and second retention members 110, 112 are positioned to secure the safety cable 32 relative to the component 28 and the anti-rotation bracket 30, thereby inhibiting unthreading rotation of the component 28.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms "a," "an," and "the" refer to one or more than one, unless the context clearly dictates otherwise. For example, the term "comprising a specimen" includes single or plural specimens and is considered equivalent to the phrase "comprising at least one specimen." The term "or" refers to a single element of stated alternative elements or a combination of two or more elements unless the context clearly indicates otherwise. As used herein, "comprises" means "includes." Thus, "comprising A or B," means "including A or B, or A and B," without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

The terms “substantially,” “about,” “approximately,” and other similar terms of approximation used throughout this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims, and should be understood as falling within the scope of the claims unless explicitly stated otherwise.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures--such as alternative materials, structures, configurations, methods, devices, and components, and so on--may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

What is claimed is:

1. An anti-rotation mounting assembly for an aircraft structure, the anti-rotation mounting assembly comprising:
a base structural member including a threaded aperture and a dowel aperture, the threaded aperture extending along a mating axis, the dowel aperture disposed radially outward of the threaded aperture;
a component including a threaded element, the threaded element engaged with the base structural member at the threaded aperture;
an anti-rotation bracket including a first body portion, a second body portion, and a third body portion, the first body portion including a ring and a dowel, the ring disposed axially between and contacting the base structural member and the component, the ring circumscribing the threaded element, the dowel disposed within the dowel aperture, the second body portion extending between and to the first body portion and the third body portion, the third body portion disposed radially outward of the component; and
a safety cable extending between and to a first cable end and a second cable end, the safety cable engaged with the component at the first cable end, the safety cable engaged with the third body portion at the second cable end.

2. The anti-rotation mounting assembly of claim 1, wherein the threaded aperture extends through the base structural member from a second base end toward a first base end along the mating axis.

3. The anti-rotation mounting assembly of claim 1, wherein the dowel aperture is formed in the base structural member at a circumferential position radially outward of the threaded aperture.

4. The anti-rotation mounting assembly of claim 1, wherein the base structural member forms a mating surface extending radially outward from the threaded aperture, and the ring is disposed in contact with the mating surface.

5. The anti-rotation mounting assembly of claim 4, wherein the ring is disposed axially between the mating surface of the base structural member and a mating surface of the component.

6. The anti-rotation mounting assembly of claim 4, wherein the dowel is disposed on the ring and projects axially outward from the ring toward the base structural member.

7. The anti-rotation mounting assembly of claim 1, wherein the dowel extends parallel to the mating axis.

8. The anti-rotation mounting assembly of claim 1, wherein the second body portion includes an axial segment extending from the ring and a radial segment extending from the axial segment.

9. The anti-rotation mounting assembly of claim 8, wherein the third body portion extends axially from the radial segment and is oriented substantially orthogonal to the ring.

10. The anti-rotation mounting assembly of claim 1, wherein the component forms a cable groove recessed into an outer radial side of the component.

11. The anti-rotation mounting assembly of claim 10, wherein the cable groove extends circumferentially about the mating axis.

12. The anti-rotation mounting assembly of claim 10, wherein the component forms a first cable aperture extending through the component body, and the safety cable extends through the first cable aperture from the cable groove to an exterior of the component body.

13. The anti-rotation mounting assembly of claim 12, wherein the safety cable extends through the first cable aperture in a direction transverse to a radial orientation of the cable groove.

14. The anti-rotation mounting assembly of claim 10, wherein the third body portion forms a second cable aperture disposed at an axial position of the cable groove.

15. The anti-rotation mounting assembly of claim 1, wherein the ring forms a center aperture extending along the mating axis, the threaded element extends through the center aperture with radial clearance, and the ring is disposed axially between the base structural member and the component.

16. A method comprising:
mounting a base structural member to a structure, the base structural member including a threaded aperture extending along a mating axis and a dowel aperture disposed radially outward of the threaded aperture;
positioning an anti-rotation bracket relative to the base structural member such that a dowel of the anti-rotation bracket is received within the dowel aperture, the anti-rotation bracket including a ring and a third body portion disposed radially outward of the component;
threading a threaded element of the component into the threaded aperture such that the ring is disposed axially between and contacts the base structural member and the component; and
routing a safety cable between the component and the third body portion of the anti-rotation bracket, including extending the safety cable through a first cable aperture formed in the component, through a cable groove formed in the component, and through a second cable aperture formed in the third body portion.

17. The method of claim 16, further comprising routing the safety cable circumferentially about the mating axis in a direction opposing an unthreading rotational direction of the component.

18. The method of claim 16, further comprising positioning the ring between the base structural member and the component during threading of the threaded element such that the ring contacts both the base structural member and the component.

19. The method of claim 16, further comprising engaging the dowel of the anti-rotation bracket within the dowel aperture prior to threading the threaded element into the threaded aperture.

20. The method of claim 16, further comprising fixing a first retention member on the safety cable adjacent the first cable end and fixing a second retention member on the safety cable adjacent the second cable end after routing the safety cable through the first cable aperture, the cable groove, and the second cable aperture.
